(19) United States
(12) Patent Application Publication
(10) Pub. No.: US 2007/0182891 A1
(43) Pub. Date: Aug. 9, 2007

(54) DISPLAY MEDIUM AND METHOD OF MANUFACTURING THE SAME

(75) Inventor: Yoshito Toyoda, Nagoya-shi, Aichi-ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 11/734,222

(22) Filed: Apr. 11, 2007

Related U.S. Application Data
(63) Continuation-in-part of application No. PCT/JP05/17817, filed on Sep. 28, 2005.

(30) Foreign Application Priority Data
Oct. 15, 2004 (JP) 2004-301550

(51) Int. Cl. G02F 1/1333

(52) U.S. Cl. 349/111

(57) ABSTRACT

A display medium includes a first substrate, a second substrate and a spacer. The first substrate has a display surface on which an image having a plurality of pixels is displayed. The second substrate opposes to the first substrate to form a liquid chamber between the first substrate and the second substrate. The spacer is disposed between the first substrate and the second substrate to seal the liquid chamber. Gas and display liquid including a plurality of charged particles are confined in the liquid chamber so that the gas partitions the display liquid by each pixel.

### BACKGROUND OF THE INVENTION

1. Field of the Invention

The present invention relates to a display medium and a method of the same, particularly relates to a display medium capable of suppressing agglomeration and bias of charged particles and being manufactured easily and a method of manufacturing the same.

2. Description of Related Art

Japanese Patent Application Publication No. 59-34518 discloses a display medium utilizing an electrophoretic phenomenon. This display medium includes small compartments divided by partition walls between two substrate films, and display liquid in which charged particles are dispersed is held with being divided in the respective small compartments. If the display liquid is not divided, when the display liquid is left for a long time with the display surface tilted to the horizontal direction, charged particles in the display medium settle out downward in the vertical direction, thereby causing bias and agglomeration of charged particles in the display medium. Accordingly, the display medium disclosed in Japanese Patent Application Publication No. 59-34518 can suppress such bias and agglomeration of charged particles by dividing the display liquid with the partition walls.

Further, there is known also a display medium manufactured by encapsulating display liquid in which charged particles are dispersed in microcapsules in order to obtain a similar advantage and providing the microcapsules two-dimensionally between a pair of substrates.

### SUMMARY OF THE INVENTION

However, it is difficult to manufacture microcapsules having same size and arrange the microcapsules in one layer between the substrate for manufacturing the display medium including the microcapsules. Further, in the display medium disclosed in Japanese Patent Application Publication No. 59-34518, it is difficult to provide partition walls for manufacturing the display medium since air tends to accumulate when injecting display liquid in each of the small compartments divided by the partition walls.

In view of the above-described drawbacks, it is an objective of the present invention to provide a display medium capable of suppressing agglomeration and bias of charged particles and being manufactured easily and a method of manufacturing the same.

In order to attain the above and other objects, the present invention provides a display medium including a first substrate, a second substrate and a spacer. The first substrate has a display surface on which an image having a plurality of pixels is displayed. The second substrate opposes to the first substrate to form a liquid chamber between the first substrate and the second substrate. The spacer is disposed between the first substrate and the second substrate to seal the liquid chamber. Gas and display liquid including a plurality of charged particles are confined in the liquid chamber so that the gas partitions the display liquid by each pixel.

Another aspect of the present invention provides a method of manufacturing a display medium. The display includes a first substrate and a second substrate opposing to the first substrate to form a liquid chamber between the first substrate and the second substrate. Gas and display liquid including a plurality of charged particles are confined in the liquid chamber so that the gas partitions the display liquid. The method includes a forming step, an interposing step, a providing step, an injecting step, a removing step, a sealing step, and a fixing step. The forming step forms, on the first substrate, a plurality of liquid affinitive areas having better wettability to the display liquid than gas contact areas for contacting the gas or a plurality of convex portions protruding inward the liquid chamber in comparison to the gas contact areas After executing the forming step, the interposing step interposes an elastic spacer on which an ejection port is formed between the first substrate and the second substrate. After executing the interposing step, the providing step provides at least one of the first substrate and the second substrate with a pressing pressure so that the first substrate and the second substrate approximate to each other. After executing the providing step, the injecting step injects the display liquid from the injection port into the liquid chamber. After executing the injecting step, the removing step removes a predetermined amount of pressing pressure from the pressing pressure. After executing the removing step, the sealing step seals the injection port. After executing the sealing step, the fixing step fixes a distance between the first substrate and the second substrate.

Another aspect of the present invention provides a method of manufacturing a display medium. The display includes a first substrate and a second substrate opposing to the first substrate to form a liquid chamber between the first substrate and the second substrate. Gas and display liquid including a plurality of charged particles are confined in the liquid chamber so that the gas partitions the display liquid. The method includes a forming step, a providing step, an opposing step, and an interposing step. The forming step forms, on the first substrate, a plurality of liquid affinitive areas having better wettability to the display liquid than gas contact areas for contacting the gas or a plurality of convex portions protruding inward the liquid chamber in comparison to the gas contact areas, After executing the forming step, the providing step provides the display liquid on the display liquid affinitive areas or the convex portions by means of an ink jet printer. After executing the providing step, the opposing step opposes the first substrate and the second substrate to each other so that the display liquid contacts both of the first substrate and the second substrate. After executing the opposing step, the interposing step interposes a spacer between the first substrate and the second substrate to maintain a distance the first substrate and the second substrate.

### BRIEF DESCRIPTION OF THE DRAWINGS

The above and other objects, features and advantages of the invention will become more apparent from reading the following description of the preferred embodiments taken in connection with the accompanying drawings in which:

FIG. 1 is a perspective view showing a display unit provided with a display panel according to a first embodiment of the present invention;

FIG. 2 is a block diagram showing the electric configuration of the display unit shown in FIG. 1;

FIG. 3A is a schematic plan view showing the display surface side of an electrophoretic display panel;

FIG. 3B is a B-B cross sectional view showing the electrophoretic display panel shown in FIG. 3A;

FIG. 4 is a plan view showing a protective layer seen from a surface side composing a liquid chamber;

FIG. 5 is a view showing a display liquid injected into the liquid chamber composed of the protective layer and the surface of a spacer;

FIG. 6A is a view showing a state where the display liquid is provided in a display liquid affinitive area treated so as to have a contact angle θ with the display liquid of smaller than 90 degrees;

FIG. 6B is a view showing a state where the display liquid is provided in a display liquid affinitive area treated so as to have a contact angle θ with the display liquid of smaller than 90 degrees;

FIG. 6C is a view showing a state where the display liquid is provided in an area having a contact angle θ with the display liquid of equal to or larger than 90 degrees;

FIG. 6D is a view showing a state where the display liquid is provided in an area having a contact angle θ with the display liquid of equal to or larger than 90 degrees;

FIG. 7A is a view showing a manufacturing process in a manufacturing method of a display medium according to the first embodiment of the present invention;

FIG. 7B is a view showing the manufacturing process in the manufacturing method of a display medium according to the first embodiment of the present invention;

FIG. 7C is a view showing the manufacturing process in the manufacturing method of a display medium according to the first embodiment of the present invention;

FIG. 7D is a view showing the manufacturing process in the manufacturing method of a display medium according to the first embodiment of the present invention;

FIG. 7E is a view showing the manufacturing process in the manufacturing method of a display medium according to the first embodiment of the present invention;

FIG. 8A is a schematic plan view showing the display surface side of a display panel according to a second embodiment of the present invention;

FIG. 8B is a B-B cross sectional view showing the display panel shown in FIG. 8A;

FIG. 9 is a plan view showing a protective layer seen from a surface side composing a liquid chamber;

FIG. 10 is a view showing a display liquid provided in the liquid chamber composed of the protective layer and the surface of a spacer;

FIG. 11A is a view showing a manufacturing process in a manufacturing method of a display medium according to the second embodiment of the present invention;

FIG. 11B is a view showing the manufacturing process in the manufacturing method of a display medium according to the second embodiment of the present invention;

FIG. 11C is a view showing the manufacturing process in the manufacturing method of a display medium according to the second embodiment of the present invention;

FIG. 11D is a view showing the manufacturing process in the manufacturing method of a display medium according to the second embodiment of the present invention;

FIG. 11E is a view showing the manufacturing process in the manufacturing method of a display medium according to the second embodiment of the present invention;

FIG. 11F is a view showing the manufacturing process in the manufacturing method of a display medium according to the second embodiment of the present invention;

FIG. 11G is a view showing the manufacturing process in the manufacturing method of a display medium according to the second embodiment of the present invention; and

FIG. 12 is a plan view showing a protective layer seen from a surface side composing a liquid chamber.

### DETAILED DESCRIPTION OF THE PREFERRED EMBODIMENTS

A display medium and method of manufacturing the same according to preferred embodiments of the present invention will be described while referring to the accompanying drawings wherein like parts and components are designated by the same reference numerals to avoid duplicating description

In the following description, the expressions “front”, “rear”, “upper”, “lower”, “right”, and “left.” are used to define the various parts when the display medium is disposed in an orientation in which it is intended to be used.

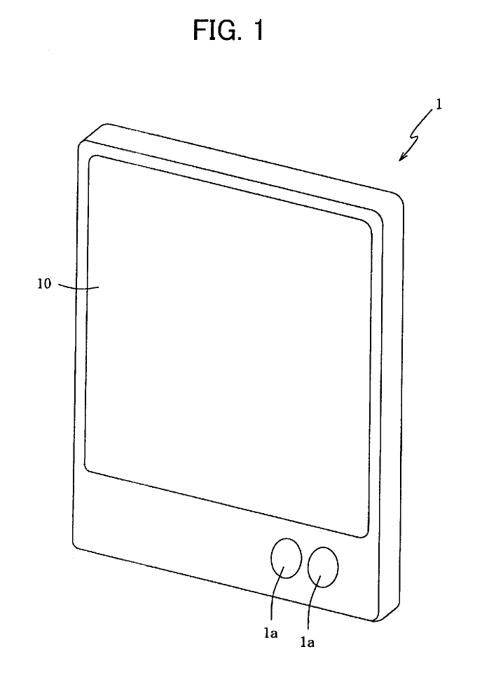

FIG. 1 is a perspective view showing a display unit 10 provided with a display panel 10 according to a first embodiment of the present invention. As shown in FIG. 1, the display unit 1 includes an electrophoretic display panel 10 and an operation button 1a. Based on the operations of the operation button 1a by a user, a desired image can be displayed on the electrophoretic display panel 10.

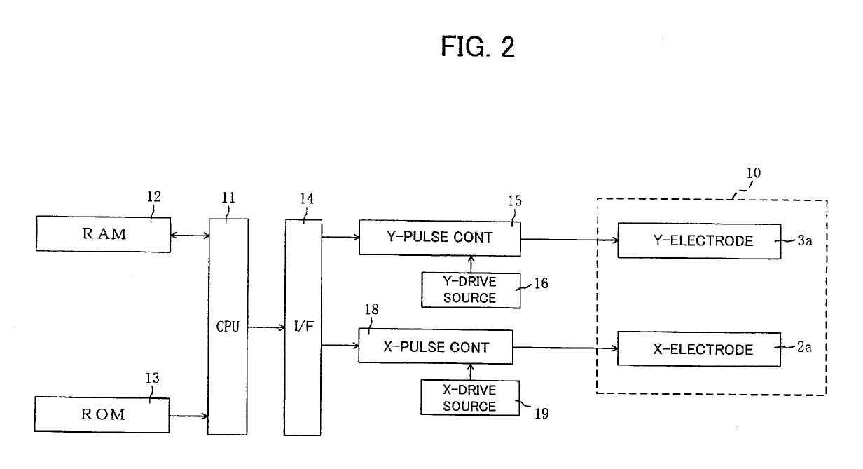

FIG. 2 is a block diagram showing the electric configuration of the display unit 1 shown in FIG. 1. As shown in FIG. 2, the display unit 1 includes an electrophoretic display panel 10 for displaying images, a CPU 11 for controlling the operations of the entire unit, a RAM 12, a ROM 13, an image interface 14, a Y pulse voltage control circuit 15, a Y drive power source 16, an X pulse voltage control circuit 18, and an X drive power source 19. Further, the electrophoretic display panel 10 includes an X electrode 2a and a Y electrode 3a.

The CPU 11 transmits pixel data to the image interface 14 based on image data stored in the RAM 12. The image interface 14 performs various processings on the pixel data outputted from the CPU 11 and outputs signals to the Y pulse voltage control circuit 15 and the X pulse voltage control circuit 18.

The Y pulse voltage control circuit 15 outputs the voltage supplied from the Y drive power source 16 to the Y electrode 3a of the electrophoretic panel 10 according to a signal outputted from the image interface 14. Further, the X pulse voltage control circuit 18 outputs the voltage supplied from the X drive power source 19 to the X electrode 2a of the electrophoretic panel 10 according to a signal outputted from the image interface 14.

A voltage is applied to the X and Y electrodes 2a and 3a respectively by the Y pulse voltage control circuit 15 and the X pulse voltage control circuit 18, and images are formed on the electrophoretic display panel 10 based on the potential difference between the X and Y electrodes 2a and 3a.

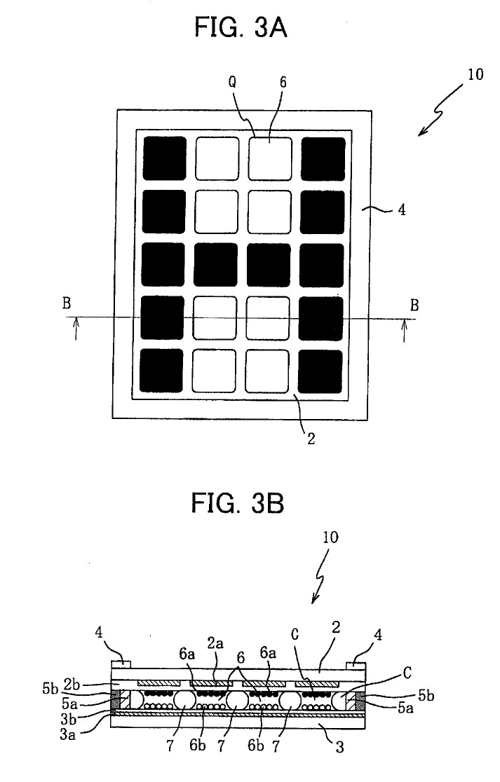

Now, the configuration of the electrophoretic display panel 10 will be described in detail with reference to FIGS. 3A and 3B. FIG. 3A is a schematic plan view showing the display surface side of an electrophoretic display panel 10. FIG. 3B is a B-B cross sectional view showing the electrophoretic display panel 10 shown in FIG. 3A.

As shown in FIG. 3B, the electrophoretic display panel 10 includes a first substrate 2, the X electrode 2a, a protective layer 2b, a second substrate 3, the Y electrode 3a, a protective layer 3b, a frame body 4, a spacer 5a, and a display liquid 6.

The first substrate 2 composing the display surface is a sheet-like member made of resin or glass having optical transparency. The X electrode 2a and the protective layer 2b covering the X electrode 2a are provided on the back surface side of the display surface. The second substrate 3 is also a sheet-like member made of a similar material as for the first substrate 2. The Y electrode 3a and the protective layer 3b covering the Y electrode 3a are provided on the surface of the side opposing to the first substrate 2. The first and second substrates 2 and 3 are arranged to be opposed to each other so that the distance between the protective layers 2b and 3b is, for example, about 30 μm.

The X electrode 2a is an electrode having one polarity to impart an electric field to the display liquid 6 and is shaped like a plurality of lines. For example, any one of metals, semiconductors, conductive resins and conductive paints can be used for the X electrode 2a as long as the X electrode 2a has conductivity and optical transparency. The X electrode 2a is formed on the first substrate 2 by means of known electroless plating method, spattering method, evaporation method or screen printing method, in combination with an etching process if needed.

The Y electrode 3a is an electrode having the other polarity to impart an electric field to the display liquid 6 and is shaped like a plurality of lines in a direction perpendicular to the X electrode 2a. The Y electrode 3a is formed on the second substrate 3 by using similar material and method as for the X electrode 2a. The display liquid 6 is arranged corresponding to each of the crossings of the X and Y electrodes 2a and 3a, and each display liquid 6 corresponding to each of the crossings composes a pixel P.

The frame body 4 surrounds the periphery of the display surface side of the first substrate 2. The spacer 5a is a sealing resin to prevent the display liquid in the liquid chamber C from leaking. The liquid chamber C means a space surrounded by the surface of the spacer 5a, the protective layer 2b and the protective layer 3b.

The display liquid 6 includes a plurality of black charged particles 6a and a plurality of white charged particles 6b that are dispersed, and is injected into the liquid chamber C. The plurality of black charged particles 6a and the plurality of white charged particles 6b move to the first substrate 2 side or second substrate 3 side according to the direction of the electric field.

The display liquid 6 may include paraffin hydrocarbons (normal paraffin, isoparaffin), halogenated hydrocarbons or silicon oils. The black charged particles 6a and white charged particles 6b may include black carbon blacks or white titanium oxides, or colored organic pigments such as phthalocyanine pigments covered with a polymer resin, or fine polymer beads colored by known dyes such as azoic dyes or quinoline dyes.

In addition, a charge control agent may be used to stabilize the charging characteristics of the respective charged particles 6a and 6b. A known material used for electrostatic recording toner is preferable. Average particle size of each of the charged particles 6a and 6b is about 0.1 μm to 10 μm.

As shown in FIG. 3A, on the display panel 10, for a pixel of which electric field is generated so that the X electrode 2a is positive with respect to the Y electrode 3b, the negatively charged black charged particles 6a move to the first substrate 2 side forming the display surface and the positively charged white charged particles 6b move to the second substrate 3 side, thereby rendering the pixel into a display state.

On the other hand, for a pixel of which electric field is generated so that the Y electrode 3a is negative with respective to the X electrode 2a, the positively charged white charged particles 6b move to the first substrate 2 side forming the display surface and the negatively charged black charged particles 6a move to the second substrate 3 side, thereby rendering the pixel into a non-display state. In addition, in FIG. 3A, the contour Q of the display liquid 6 in the non-display state is shown to facilitate the understanding of the figure, and however, such a contour Q is not displayed in a normal condition.

The gas 7 is an inert gas. The inert gas may include noble gases such as helium and argon or nitrogen gas. As shown in FIG. 3B, the display liquid 6 is partitioned into each area (by each pixel P in the first embodiment) by the gas 7.

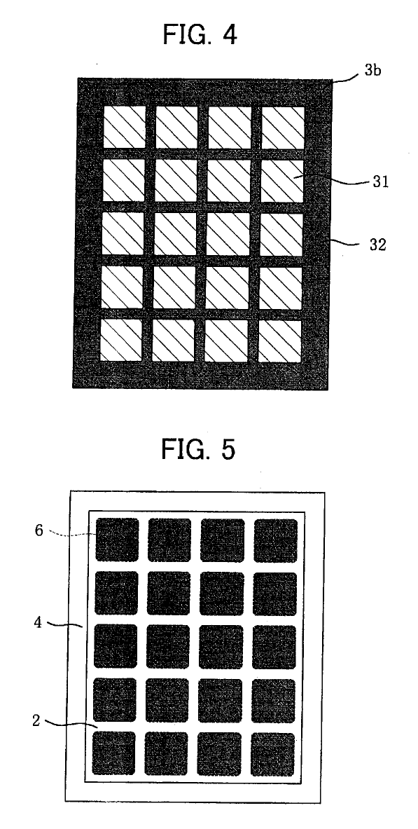

FIG. 4 is a plan view showing the protective layer 3b seen from the first substrate 2 side. As shown in FIG. 4, areas 31 and an area 32 are provided in the protective layer 3b. In addition, all corners of each of the areas 31 are formed to have an angle of 90 degrees, respectively, and however, each of the corners may have a rounded shape.

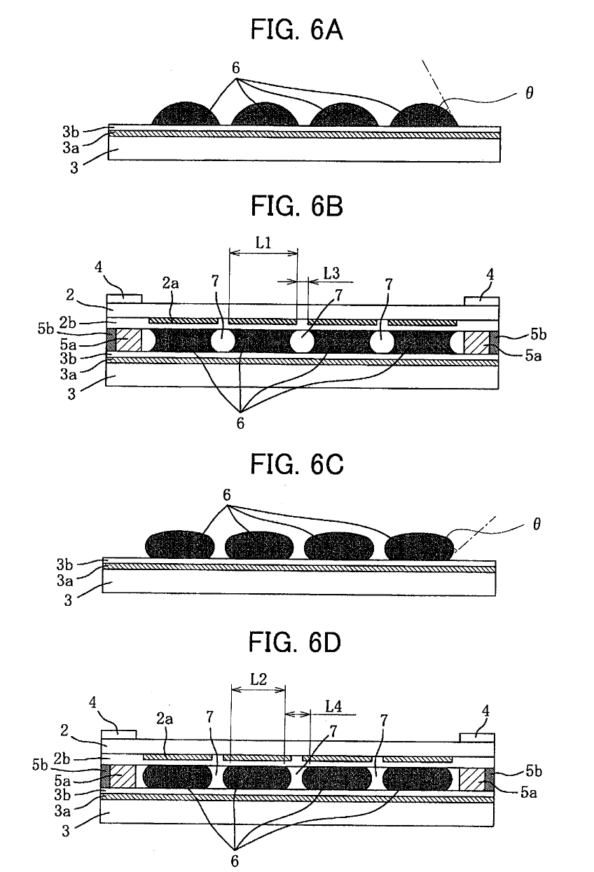

Each of the areas 31 is substantially quadrangular and is provided in an area coming into contact with the display liquid 6. That is, an area 31 is provided corresponding to each of the crossings of the X and Y electrodes 2a and 3a (refer to FIG. 3B) composing the pixel P. On the other hand, the area 32 is provided in the area in which the gas 7 is to be contained, that is, substantially on the entire surface except the areas 31. Surface treatment is performed on the areas 31 to impart the areas 31 better wettability for the display liquid 6 than the area 32. Thereby, the contact angle between the each of the areas 31 and the display liquid 6 becomes smaller than that between the area 32 and the display liquid 6. The “contact” angle means an angle formed between a solid matter being in contact with the display liquid and a liquid to which surface tension is exerted (refer to FIGS. 6A and 6B). The surface treatment to form the areas 31 will be described later in detail.

FIG. 5 is a view showing the display liquid 6 when the first substrate 2 side is seen from the second substrate side 3. As shown in FIG. 5, the display liquid 6 injected into or provided in the liquid chamber C moves spontaneously to the areas 31 formed in the protective layer 3b and having better wettability, thereby suppressing the movement of the display liquid 6 to the area 32. That is, the display liquid 6 is spaced by the gas 7 in the liquid chamber by each pixel.

According to the display panel 10 of the first embodiment, since the display liquid 6 is partitioned by the gas 7 with each area, the charged particles 6a and 6b in the display liquid 6 are held by the surface tension of the display liquid 6, thereby being prevented from moving to the display liquid of any other area over the gas between the respective display liquids. Accordingly, even if the display unit 1 is left for a long time with the display surface tilted to the horizontal direction, the charged particles 6a and 6a do not settle down on one end, enabling the bias and agglomeration of the charged particles 6a and 6a to be suppressed without using solid partition walls. In addition, no solid partition walls for partitioning the display liquid 6 are required, thereby enabling a facilitated manufacturing method of a display medium. Further, by providing no solid partition walls, the distance between the first and second substrates 2 and 3 can be shortened, thereby enabling the charged particles to move electrophoretically with a low voltage. In contrast to a conventional electrophoretic panel having a distance of about 40 to 100 μm between the respective substrates due to the solid partitions provided between the substrates, the distance between the respective substrates of the display panel 10 of the first embodiment can be reduced to about 10 to 30 μm.

Further, the switching between display state and non-display state can be performed in areas where the display liquid 6 is in contact with the protective layers 6a and 6b. Accordingly, in order to improve the contrast ratio of the display panel 10, each of the areas where the display liquid 6 is in contact with the protective layers 6a and 6b need be enlarged. For this purpose, the wettability of the areas 31 need be improved and the contact angle need be reduced. Preferably, each of the areas 31 is formed to render the contact angle with the display liquid 6 smaller than 90 degrees.

The contact angle will be described with reference to FIGS. 6A to 6D. FIGS. 6A and 6B are views showing a state where the display liquid 6 is provided in the areas 31 treated so as to have a contact angle θ with the display liquid 6 of smaller than 90 degrees. FIGS. 6C and 6D are views showing a state where the display liquid 6 is provided in an area having a contact angle θ with the display liquid 6 of equal to or larger than 90 degrees.

When the contact angle between each of the areas 31 and the display liquid 6 is smaller than 90 degrees, as shown in FIG. 6A, the display liquid 6 has a shape tapered toward the opposing substrate. When the display liquid 6 comes into contact with both surfaces of the protective layers 2b and 3b, as shown in FIG. 6B, the surface of display liquid 6 in the liquid chamber C is a concave to the gaseous side (gas 7). Therefore, each of the contact areas L1 with the display liquid 6 on the surface of the first substrate 2 side composing the display surface can be rendered larger in comparison to each of non-contact areas L3 with the display liquid 6. As a result thereof, an enlarged displayable area of the display panel 10 enables a high contrast ratio to be obtained.

On the other hand, when the contact angle with the display liquid is equal to or larger than 90 degrees, as shown in FIG. 6C, the display liquid 6 has a shape of ellipse. When the display liquid 6 comes into contact with both surfaces of the protective layers 6a and 6b, as shown in FIG. 6D, the surface of display liquid 6 in the liquid chamber C is a convex to the gaseous side (gas 7). Therefore, each of non-contact areas L4 with the display liquid 6 becomes larger in comparison to the non-contact areas L3 in FIG. 6B. As a result thereof, a reduced displayable area of the display panel 10 lowers the contrast ratio.

As described above, by reducing the non-contact areas that do not contribute the improvement of the contrast ratio, the contrast ratio of the display panel 10 can be improved.

Moreover, preferably, each of the areas 31 is formed to render the contact angle with the display liquid 6 equal to or smaller than 40 degrees. In this manner, the constriction shown in FIG. 6B becomes larger. So, even if external force is applied from the first substrate 2 side composing the display surface toward the second substrate 3 side to reduce the distance between the first and second substrates 2 and 3, the respective charged particles 6a and 6b can be prevented from moving by mutual contact of the adjacent display liquids 6. Moreover, preferably, the contact angle θ between each of the areas 31 and the display liquid 6 is smaller than the contact angle between the area 32 (refer to FIG. 4) and the display liquid 6, and the difference therebetween is greater than 10 degrees. In this manner, not only the display liquid 6 moves to the area 31a spontaneously and rapidly, but also the display liquid 6 provided in each of the areas 31 is suppressed more certainly to move to the area 32.

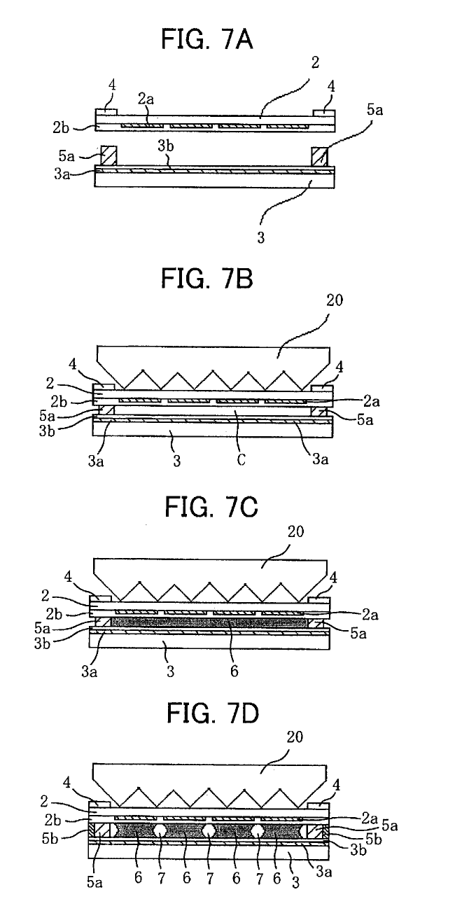

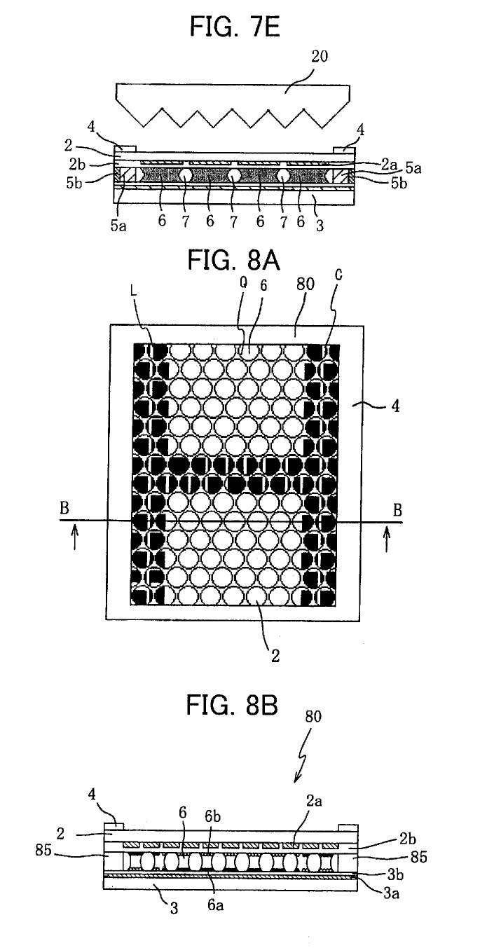

Now, manufacturing method of the display medium of the first embodiment will be described with reference to FIGS. 7A to 7E. FIGS. 7A to 7E are views showing a manufacturing process in the manufacturing method of the display medium of the first embodiment.

First, the areas 31 are formed on a second substrate 3 (substrate preparation process). Specifically, the second substrate 3 in which the Y electrode 3a and the protective layer 3b are formed is prepared, and surface treatment is performed on the surface of the protective layer 3b side of the second substrate 3 to form the areas 31. The surface treatment is performed by manufacturing a mold by resist treatment, the mold being exposed only in areas where the areas 31 are to be provided, by masking the protective layer 3b with the mold and by evaporating gold on the areas 31.

Then, as shown in FIG. 7A, the first and second substrates 2 and 3 are opposed to each other so that the surface having the areas 31 and the area 32, that is, the protective layer 3b provided in the second substrate 3, may be opposed to the protective layer 2b provided in the first substrate 2, and an elastic body spacer 5a is interposed between the first and second substrates 2 and 3. As shown in FIG. 7B, by using a holddown jig 20, pressing pressure is applied in a direction of approximating the first and second substrates 2 and 3 to each other to compress the spacer 5a by the first substrate 2 (compression process).

The liquid chamber C is formed in a space surrounded by the spacer 5a, the first substrate 2 and the second substrate 3. As a material for the spacer 5a, a rubber such as silicon rubber or butyl rubber, or a porous material containing air bubbles in the resin is preferably used, and a metallic or resin blade spring may be used if needed. In addition, an injection port (not shown) is provided in the spacer 5a.

Then, the display liquid 6 having a volume substantially identical to that of the liquid chamber C is injected from the injection port of the spacer 5a (not shown) into the liquid chamber C (display liquid injection process). As a result, as shown in FIG. 7C, the liquid chamber C is filled with the display liquid 6.

After the display liquid 6 has been injected in the display liquid injection process, the pressing pressure applied by the holddown jig 20 is reduced to decompress the compressed spacer 5a. Specifically, the pressing pressure is regulated by the restoring force of the spacer 5a so that the distance between the protective layers 2b and 3b may be about 30 μm. At this time, the liquid chamber C causes a shortage of the amount of the display liquid 6 equivalent to the enlarged volume thereof, generating a reduced-pressure state therein. Further, surface tension trying to render the surface area as small as possible and a force trying to realize stabilization by coming into contact with the display liquid affinitive portions (to render the surface energy little) are exerted to the display liquid 6. As a result thereof, as shown in FIG. 7D, the display liquid 6 moves so as to come into contact with the areas 31 (FIG. 4) of the protective layer 3b, generating a space between the respective display liquids 6.

Then, inert gas is injected from the injection port. Thereby, the space between the respective display liquids 6 is filled with the gas 7 constituted of an inert gas in the liquid chamber C in the reduced-pressure state. When the inert gas is injected, dust and moisture in the air have been removed. Moreover, the injection port is sealed by a sealing resin constituted of an epoxy adhesive (sealing process). Thereby, the display liquid 6 is prevented from leaking from the liquid chamber C. In addition, the inert gas may be injected concurrently with the decompression of the compressed spacer 5a. In this case, a process of displacing the inert gas to a space generated by the decompressed spacer 5a can be omitted.

After the injection port has been sealed in the sealing process, a gap between the first and second substrates 2 and 3 is filled with a fixing resin 5b thereby to fix the distance between the first and second substrates 2 and 3 in the thickness direction of the first and second substrates 2 and 3 (fixing process). Thereby, as shown in FIG. 7D, the distance between the first and second substrates 2 and 3 is kept even if the holddown jig 20 is removed from the first substrate 2.

According to the manufacturing method of the display medium of the present embodiment, the display liquid 6 injected into the liquid chamber C moves spontaneously so as to come into contact with the areas 31 and, as shown in FIG. 7D, is partitioned by the gas 7 with each area 31. In this manner, the display medium in which the display liquid 6 is partitioned by the gas 7 with each area can be manufactured easily.

Now, a second embodiment of the present invention will be described with reference to FIGS. 8A and 8B. FIG. 8A is a schematic plan view showing the display surface side of a display panel 80 of the second embodiment, and FIG. 8B is a B-B cross sectional view of the display panel 80 shown in FIG. 8A. In addition, in the present embodiment, the parts identical to those in the first embodiment are identified by the identical reference characters, and the descriptions thereof will be omitted.

As shown in FIG. 8B, the electrophoretic display panel 80 includes a first substrate 2, a X electrode 2a, a protective layer 2b, a second substrate 3, a Y electrode 3a, a protective layer 3b, a frame body 4, a spacer 5a, and a display liquid 6.

As shown in FIG. 5B, the display liquid 6 is partitioned by the gas 7 with each area. In the display panel 10 of the first embodiment, the display liquid 6 is arranged corresponding to each of the crossings of the X and Y electrodes 2a and 3a. In contrast thereto, in the display panel 80 of the second embodiment, there is no special relationship between the arrangement of the electrodes and the arrangement of the display liquid 6. In areas in which at least one of the X and Y electrodes 2a and 3a is not present, the charged particles 6a and 6b cannot be moved electrophoretically. Thus, as shown in FIG. 8A, the areas L in which the electrodes 2a and 3a are not present appear in the form of lines as non-display areas. In addition, in FIG. 8A, the contour Q of the display liquid 6 in the non-display state is shown to facilitate the understanding of the figure, and however, such a contour is not displayed in a normal condition.

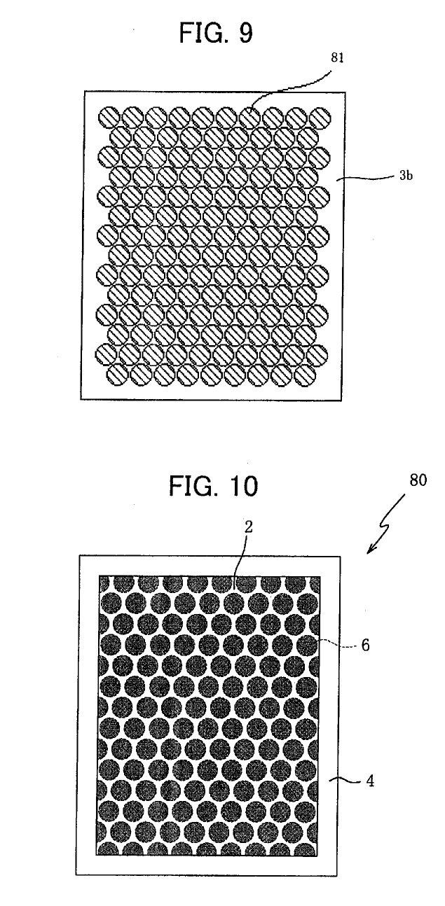

Now, the protective layer 3b will be described in detail with reference to FIG. 9. FIG. 9 is a plan view showing the protective layer 3b seen from the first substrate 2 side. As shown in FIG. 9, convex portions 81 are provided on the surface composing the liquid chamber C of the protective layer 3b.

Each of the convex portions 81 is a substantially circular area provided corresponding to areas to come into contact with the display liquid 6. The convex portions 81 are provided with being equally spaced and protrude to the protective layer 2b side as an opposing surface.

FIG. 10 is a view showing the display liquid 6 when the first substrate 2 side is seen from the second substrate side 3. As shown in FIG. 10, the display liquid 6 injected into or provided in the liquid chamber C moves due to capillary force to the convex portions 81 of which distance to the opposing surface is smaller and is suppressed to move to areas in which no convex portions 81 are provided, that is, to areas of which distance to the opposing surface is larger. Therefore, the gas 7 moves to the areas in which no convex portions 81 are provided, and the display liquid 6 is partitioned by the gas 7. Thus, also in the display panel 80 of the second embodiment, the bias and agglomeration of the charged particles 6a and 6b can be suppressed without using solid partition walls as in the display panel 10 of the first embodiment.

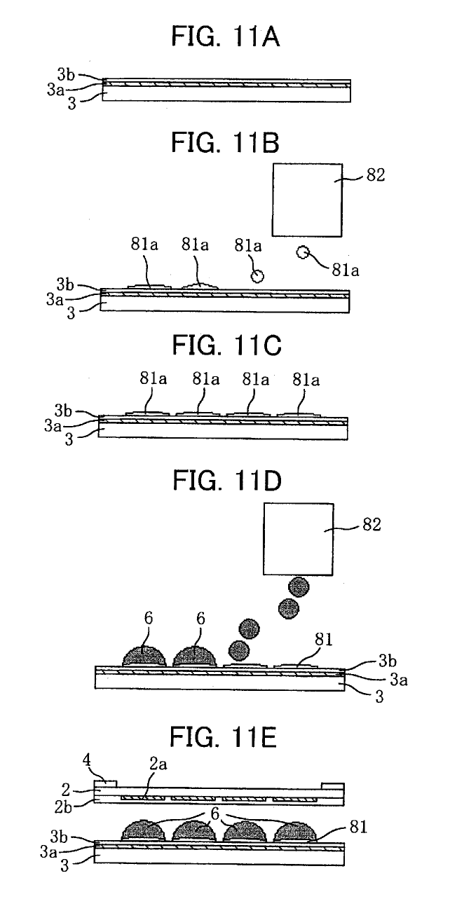

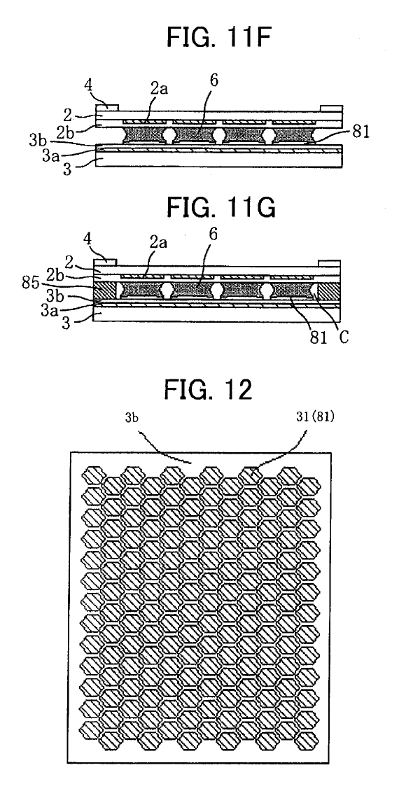

Now, a manufacturing method of the display medium of the second embodiment of the present invention will be described with reference to FIGS. 11A to 11G. FIGS. 11A to 11G are views showing a manufacturing process in the manufacturing method of the display medium of the second embodiment. Further, the parts identical to those in the first embodiment described above are identified by the identical reference characters, and the descriptions thereof will be omitted.

First, a surface on which the convex portions 81 are formed is provided on a second substrate 3 (substrate preparation process). In the substrate preparation process, as shown in FIG. 11A, a second substrate 3 in which a Y electrode 3a and a protective layer 3b are formed is prepared, and the convex portions 81 are formed on the surface of the protective layer 3b side of the second substrate 3.

Specifically, as shown in FIG. 11B, an ink 81a is discharged by an ink jet printer 82 onto areas to provide the display liquid 6, the ink 81a being constituted of a solvent in which a convex portion forming material is dissolved or dispersed, and the convex portion forming material being an organic matter such as resin or an inorganic matter such as metallic colloid. By evaporating the solvent in the ink 81a to remove other materials than the convex portion forming material, sheet-like convex portions 81 composed of the convex portion forming material as shown in FIG. 11C are formed. The ink 81a is discharged with being regulated to render the height of the convex portions 81 to substantially 1/10 (for example, about 3 μm) of the distance between the protective layers 2b and 3b in the thickness direction of the substrates 2 and 3. As a convex portion forming material, wax, polyvinyl alcohol, polyvinyl pyrrolidone, water-soluble cellulose, display liquid 6-insoluble dye, styrene particle, acryl particle, polythiohene, display liquid 6-insoluble pigment, or a combination thereof is preferably used. The method of evaporating the solvent in the ink 81a includes, for example, a vacuum drying method, a heat drying method or a combination thereof.

Then, as shown in FIG. 11D, the display liquid 6 in which a plurality of charged particles 6a and 6b are dispersed is provided by the ink jet printer 82 on the convex portions 81 on the surface provided on the second substrate 3 prepared in the substrate preparation process. The display liquid 6 discharged onto the convex portions 81 has a shape of liquid drop on each of the convex portions 81 due to the surface tension (display liquid providing process).

Then, as shown in FIG. 11E, a first substrate 2 on which an X electrode 2a, a protective layer 2b and a frame body 4 are provided is prepared. After the display liquid 6 has been provided in the display liquid providing process, as shown in FIG. 11F, the first and second substrates 2 and 3 are opposed to each other and are held with the display liquid 6 being in contact with the surface of the first substrate 2 side and the surface of the second substrate 3 side, and the protective layers 2b and 3b being spaced by a predetermined distance (for example, on the order of about 30 μm) in the thickness direction of the substrates 2 and 3 (substrate holding process). The display liquid 6 provided on the convex portions 81 is held due to capillary force on the convex portions 81 of which distance to the opposing surface is smaller and is suppressed to move to areas in which no convex portions 81 are provided. Thereby, a configuration in which the adjacent display liquids 6 are partitioned by the gas 7 with each convex portion 81 is realized.

Then, as shown in FIG. 11G, being held in the substrate holding process, the first and second substrates 2 and 3 are fixed with a spacer 85 being interposed therebetween (fixing process). The space is made of, for example, an epoxy adhesive and seals the liquid chamber C between the first and second substrates 2 and 3.

According to the manufacturing method of the display medium of the second embodiment, a display medium in which the display liquid 6 is partitioned by a gas with each area can be manufactured easily as in the manufacturing method of the display medium of the first embodiment.

While the invention has been described in detail with reference to the specific embodiment thereof, it would be apparent to those skilled in the art that various changes and modifications may be made therein without departing from the spirit of the invention.

For example, the substrates 2 and 3 may be made of a flexible film such as polyester film or polyimide film. In this manner, the solid partition walls provided in the conventional electrophoretic display medium are not required. In addition, a flexible display medium can be obtained, imparting more flexibility to the display medium.

Further, according to the above-described embodiments, the X electrode 2a is provided on the first substrate 2 and the Y electrode 3a is provided on the second substrate 3. However, a display medium without these electrodes 2a and 3a may be manufactured. For example, by using a writing device capable of applying voltage on the outer surfaces of the first and second substrates 2 and 3, the charged particles 6a and 6b may be moved electrophoretically to display an image.

Further, as shown in FIG. 12, by substantially hexagonally forming each of the areas 31 or the convex portions 81 (honeycomb-like), the areas 31 or the convex portions 81 can be provided densely. Thereby, since the total area of the areas 31 or the convex portions 81 on the surface composing the liquid chamber C becomes larger, the total area of the contact areas L1 (FIG. 6B) with the display liquid 6 on the surface of the first substrate 2 side composing the display surface becomes larger in comparison to the total area of non-contact areas L3 (FIG. 6B) with the display liquid 6. Accordingly, an enlarged displayable area enables a high contrast ratio to be obtained.

Further, the cross sectional shape of the areas 31 or the convex portions 81 may be one of polygons equal to or more than a quadrangle or a circle. If the areas 31 or the convex portions 81 are triangle, the surface treatment for providing the areas 31 or the convex portions 81 is difficult. However, if the areas 31 or the convex portions 81 are one of polygons equal to or more than a quadrangle or a circle, the areas 31 or the convex portions 81 can be provided easily.

Further, the manufacturing methods of the display medium of the first and second embodiments include a gas introduction process of introducing an inert gas to stabilize the gas 7 for a long time even if oxygen or carbon dioxide in the air does not affect the gas 7 adversely. However, if no oxygen or carbon dioxide in the air affects the gas 7 adversely or if the gas 7 need not be stabilized for a long time, air may be used as the gas 7 and the gas introduction process may be omitted.

Further, in the second embodiments areas 31 are formed by evaporating gold. However, the method of forming the areas 31 is not limited thereto. The areas 31 having good wettability for the display liquid 6 may be formed, for example, by preparing a mold by resist treatment, the mold being exposed in areas where the areas 31 are to be provided, by masking the surface provided in the first or second substrate 2 or 3 with the mold and by forming fine unevenness having a height of substantial several nm by means of plasma treatment.

Further, in the second embodiment, convex portions 81 are formed by discharging the ink 81a onto areas to come into contact with the display liquid 6. However, the method of forming the convex portions 81 is not limited thereto. The convex portions 81 may be formed, for example, by masking the surface provided in the first or second substrate 2 or 3 with a mold corresponding to areas in which convex portions 81 are to be formed and by spraying fine particles on the surface by means of sandblast treatment. Further, the convex portions 81 may be formed by masking the surface similarly as described above and irradiating metallic atoms by means of spattering treatment to accumulate them on the surface. Further, the convex portions 81 protruding in comparison to the areas in which the gas 7 is to be provided may be formed by masking the surface provided in the first or second substrate 2 or 3 with a mold exposed in areas where the gas 7 is to be provided and by etching the exposed areas by means of plasma etching treatment.

Further, in substrate preparation processes of the second embodiment, the areas 31 or the convex portions 81 may be formed by performing printing or transfer printing by means of screen printing or a stamp with an ink containing a convex portion forming material as an organic matter such as resin or an inorganic matter as metallic colloid or a display liquid affinitive area material of good wettability for the display liquid.

Further, in the above-described embodiments, the areas 31 or the convex portions 81 are formed only on the second substrate 3 side. However, the areas 31 or the convex portions 81 may be formed on both the first substrate 2 side and the second substrate 3 side. In this case, each of the areas 31 or the convex portions 81 formed on the second substrate 3 side is preferably configured to have a larger area in comparison to each of the areas 31 or the convex portions 81 formed on the first substrate 2 side. Thereby lowering of the permeability of the display surface is suppressed, improving the visibility and the stability of the display liquid.

What is claimed is:

1. A display medium comprising:
a first substrate having a display surface on which an image having a plurality of pixels is displayed;
a second substrate opposing to the first substrate to form a liquid chamber between the first substrate and the second substrate; and
a spacer disposed between the first substrate and the second substrate to seal the liquid chamber, gas and display liquid including a plurality of charged particles being confined in the liquid chamber so that the gas partitions the display liquid by each pixel.

2. The display medium according to claim 1, wherein at least one of the first substrate, the second substrate, and the spacer has a plurality of liquid contact areas contacting the display liquid, and a plurality of gas contact areas contacting the gas,
wherein affinity of the liquid contact area to the display liquid is higher than affinity of the gas contact area to the display liquid.

3. The display medium according to claim 2, wherein the display liquid contacts the liquid contact area at a first contact angle smaller than 90 degrees.

4. The display medium according to claim 3, wherein the display liquid contacts the gas contact area at a second contact angle if the display liquid contacts the gas contact area,
wherein the first contact angle is smaller than the second contact angle by equal to or greater than 10 degrees.

5. The display medium according to claim 2, wherein a shape of the display liquid contact area is a polygon equal to or more than a quadrangle or a circle.

6. The display medium according to claim 5, wherein the shape of the liquid contact area is a hexagon.

7. The display medium according to claim 2, wherein the liquid contact areas are provided on the second substrate.

8. The display medium according to claim 7, wherein the liquid contact areas are provided on the first substrate, total area of the liquid contact areas provided on the second substrate being larger than total area of the liquid contact areas provided on the first substrate.

9. The display medium according to claim 1, at least one of the first substrate, the second substrate, and the spacer has a plurality of liquid contact areas contacting the display liquid, and a plurality of gas contact areas contacting the gas, the liquid contact area protruding inward the liquid chamber in comparison to the gas contact area.

10. The display medium according to claim 9, wherein a shape of the display liquid contact area is a polygon equal to or more than a quadrangle or a circle.

11. The display medium according to claim 9, wherein the shape of the liquid contact area is a hexagon.

12. The display medium according to claim 9, wherein the liquid contact areas are provided on the second substrate.

13. The display medium according to claim 9 wherein the liquid contact areas are provided on the first substrate, total area of the liquid contact areas provided on the second substrate being larger than total area of the liquid contact areas provided on the first substrate.

14. The display medium according to claim 1, wherein the gas is inert gas.

15. A method of manufacturing a display medium including a first substrate and a second substrate opposing to the first substrate to form a liquid chamber between the first substrate and the second substrate, gas and display liquid including a plurality of charged particles being confined in the liquid chamber so that the gas partitions the display liquid, the method comprising:
forming, on the first substrate, a plurality of liquid affinitive areas having better wettability to the display liquid than gas contact areas for contacting the gas or a plurality of convex portions protruding inward the liquid chamber in comparison to the gas contact areas;
after executing the forming step, interposing an elastic spacer on which an ejection port is formed between the first substrate and the second substrate;
after executing the interposing step, providing at least one of the first substrate and the second substrate with a pressing pressure so that the first substrate and the second substrate approximate to each other;
after executing the providing step, injecting the display liquid from the injection port into the liquid chamber;
after executing the injecting step, removing a predetermined amount of pressing pressure from the pressing pressure;
after executing the removing step, sealing the injection port; and
after executing the sealing step, fixing a distance between the first substrate and the second substrate.

16. The method according to claim 15, wherein the plurality of display liquid affinitive areas are formed from an ink ejected from an ink jet printer, the ink containing a display liquid affinitive area material having a predetermined wettability for the display liquid or a convex portion forming material as an organic or inorganic matter.

17. The method according to claim 16, wherein other materials than the display liquid affinitive area material or the convex portion forming material are removed from in the ink.

18. A method of manufacturing a display medium including a first substrate and a second substrate opposing to the first substrate to form a liquid chamber between the first substrate and the second substrate, gas and display liquid including a plurality of charged particles being confined in the liquid chamber so that the gas partitions the display liquid, the method comprising:
forming, on the first substrate, a plurality of liquid affinitive areas having better wettability to the display liquid than gas contact areas for contacting the gas or a plurality of convex portions protruding inward the liquid chamber in comparison to the gas contact areas;
after executing the forming step, providing the display liquid on the display liquid affinitive areas or the convex portions by means of an ink jet printer;
after executing the providing step, opposing the first substrate and the second substrate to each other so that the display liquid contacts both of the first substrate and the second substrate; and
after executing the opposing step, interposing a spacer between the first substrate and the second substrate to maintain a distance the first substrate and the second substrate.

19. The method according to claim 18, wherein the plurality of display liquid affinitive areas are formed from an ink ejected from an ink jet printer, the ink containing a display liquid affinitive area material having a predetermined wettability for the display liquid or a convex portion forming material as an organic or inorganic matter.

20. The method according to claim 19, wherein other materials than the display liquid affinitive area material or the convex portion forming material are removed from in the ink.
